(19) United States
(12) Patent Application Publication
(10) Pub. No.: US 2026/0295309 A1
(43) Pub. Date: Oct. 1, 2026

(54) Respiratory Mask Having a Filter Unit and a Removable Cap for the Filter Unit

(71) Applicant: Dräger Safety AG & Co. KGaA, Lubeck (DE)

(72) Inventors: Helge Goldenbaum, Lubeck (DE); Ludwig Lorenzen, Lubeck (DE)

(21) Appl. No.: 19/574,711

(22) Filed: Mar. 23, 2026

(30) Foreign Application Priority Data
Mar. 28, 2025 (DE) 102025112099.4

(51) Int. Cl. A62B 18/02

(52) U.S. Cl. CPC A62B 18/025

(57) ABSTRACT

The main body of a respiratory mask bears against the face of a user in a fluid-tight manner. A filter unit is detachably connected to the main body. A cap can be placed on the filter unit and can be removed again from the filter unit. If the cap is placed, a projection of the cap engages in a corresponding receiving element of the filter unit. The placed cap protrudes beyond the filter unit and can be reversibly compressed. If the placed cap is compressed, the projection slides out of the corresponding receiving element, and the cap can be removed. Preferably, the user can breathe purified ambient air even if the cap is placed.

### CROSS-REFERENCE TO RELATED APPLICATIONS

This application claims the priority of German Patent Application No. 102025112099.4, filed on Mar. 28, 2025, and titled “RESPIRATORY MASK HAVING A FILTER UNIT AND A REMOVABLE CAP FOR THE FILTER UNIT”, which is hereby incorporated by reference in its entirety for all nonlimiting purposes.

### TECHNICAL FIELD

The present disclosure relates to an assembly comprising a respiratory mask having a filter unit and a cap for said filter unit.

### BACKGROUND

A respiratory mask, as known from the prior art, comprises a main body and at least one filter unit. The main body bears against the face of a user (wearer) of the respiratory mask in a fluid-tight manner and covers at least the nose and mouth of the user. The or each filter unit is attached to the main body and can preferably be separated from the main body, i.e. is detachably inserted. Ambient air flowing toward the nose and mouth of the user flows through the or each filter unit on the main body. The or each filter unit filters out particles and harmful substances from the ambient air. By virtue of the respiratory mask, the user can remain in an environment in which particles and/or harmful substances occur or at least may occur in the ambient air.

### SUMMARY

The problem addressed by the present disclosure is that of providing an assembly comprising a respiratory mask, wherein the respiratory mask comprises a main body and at least one filter unit on the main body and in some situations is better protected against environmental influences than respiratory masks known from the prior art.

The problem is solved by an assembly having the features of claim 1. Advantageous embodiments are specified in the dependent claims.

The assembly according to the present disclosure comprises a respiratory mask. The respiratory mask comprises a main body. While a user wears the respiratory mask, the main body bears against the user's face in a fluid-tight manner. The main body covers at least the mouth and nose of the user. Preferably, a strap keeps the main body on the user's head.

The respiratory mask further comprises a filter unit, in one example embodiment at least two filter units. The or each filter unit can be connected to the main body, preferably detachably connected thereto, for example by means of a screw fastening. While the respiratory mask is in use, the filter unit or at least one filter unit is connected to the main body. The main body holds the or each connected filter unit.

The respiratory mask is configured as follows: Respiratory air flows from an environment surrounding the respiratory mask, through the or each connected filter unit, to the main body and reaches the mouth and nose of the user. The or each filter unit filters out particles and/or harmful substances from this respiratory air as the respiratory air flows through the filter unit. Typically, the user causes the respiratory air to flow through the filter unit to his mouth and nose by virtue of his own respiratory activity, thus sucking in the respiratory air.

The assembly further comprises at least one cap, preferably one cap for each filter unit of the respiratory mask. The cap can be placed on the filter unit and can be removed again from the filter unit. If the respiratory mask comprises two filter units, preferably at least one cap, in particular each cap, can optionally be placed on one or the other filter unit. It is also possible that the two caps are configured differently and can each be placed on just one filter unit.

The cap can be reversibly deformed. This means that the cap has a rest state, and in this rest state the cap does not change its shape and form. If the cap is deformed, the deformation gives rise to a restoring force, and the restoring force tends to return the cap to its rest state.

In a first alternative, the assembly is configured as follows: The cap comprises at least one inward-facing projection. The filter unit comprises at least one outward-facing corresponding receiving element, for example a groove or multiple projections, between which at least one recess is formed. In one example embodiment, the receiving element functions as a gripping surface. In a second alternative, the assembly is configured as follows: The filter unit comprises at least one outward-facing projection, and the cap comprises at least one inward-facing corresponding receiving element.

In both alternatives, the assembly is configured as follows: While the cap is placed on the filter unit, the or each projection engages in the or a corresponding receiving element.

The assembly is configured as follows: While the cap is placed on the filter unit, the cap protrudes beyond the filter unit, namely along a compression axis in at least one direction, preferably in two opposite directions parallel to this compression axis. Because the placed cap protrudes, the cap can be compressed parallel to the compression axis. The placed cap can be compressed along the compression axis, namely in a reversible manner. This means that, if the compression is ended, the placed cap again adopts the shape that the cap had prior to being compressed.

In the first alternative, the or each projection of the cap is at a distance from the compression axis. In the second alternative, the or each corresponding receiving element is at a distance from the compression axis.

In both alternatives, the assembly is configured as follows: If the cap is compressed along the compression axis, the or each projection slides out of the respective corresponding receiving element. The cap can then be removed from the filter unit, namely preferably by a linear movement away from the filter unit.

A user wearing the respiratory mask can remain in a spatial area in which the ambient air contains or may contain particles and/or harmful substances. The user can nevertheless still breathe in the ambient air. This is because the or each filter unit attached to the main body filters out particles and/or harmful substances from the ambient air before the ambient air reaches the mouth and nose of the user.

While a cap is placed on a filter unit, this prevents dirt particles and moisture from reaching the filter unit at least to a certain extent, ideally completely. As a result, the respiratory mask can be used, or even taken off or stored, in an area that is or may be dirty and/or damp. Such an area is found, for example, in a mine or in a production plant or in a tunnel. By virtue of the placed cap, it is not necessary to separate the or each filter unit from the main body and place it in a separate container in order to protect it against environmental influences.

According to the present disclosure, at least one projection engages in a corresponding receiving element if the cap is placed on the filter unit. This reduces the risk of the placed cap slipping off the filter unit on its own, even if the user moves his head or the filter unit strikes against a solid object.

Typically, a housing of the filter unit is configured as a rigid body, and the housing deflects the placed elastic cap out of the rest state. Due to its elasticity, the cap exerts a restoring force, and the restoring force helps to keep the cap on the filter unit. However, thanks to the projection and the corresponding receiving element, the cap is generally not kept on the filter unit by the restoring force, or not exclusively by the latter. Therefore, it is even possible that the cap is in the rest state if it is placed on the filter unit. In many cases, this reduces wear on the cap, in particular “loosening” or the occurrence of a crack or break.

According to the present disclosure, the cap can be compressed along the compression axis. As a result of the compression, the projection slides out of the corresponding receiving element, and the cap can be removed from the filter unit. This example embodiment enables a user to remove the cap from the filter unit in a single operation and using just one hand, preferably by pulling it off linearly, even if the user is wearing gloves. The user therefore does not need to remove a glove in order to remove the cap.

Thanks to the present disclosure, it is not necessary to move the cap linearly away from the filter unit in order to deform the cap by the linear movement and pull the projection out of the corresponding receiving element. In some cases, this will require a relatively large amount of force and/or time, particularly because the restoring force must be overcome by the linear movement away from the filter unit.

Furthermore, thanks to the present disclosure, it is not necessary to turn the cap in order to remove it. This is particularly advantageous for the following reason: The filter unit is often detachably connected to the main body by means of a bayonet fastening. If it were necessary to turn the cap in order to remove it from the filter unit, there would be a risk that the cap would not be removed from the filter unit, but instead turning the cap would also cause the filter unit to be turned and then no longer be connected to the main body. This is usually undesirable. In addition, turning would require a sufficiently large frictional force to occur between the cap on the one hand and the turning hand of a user or a handling machine on the other hand, which is sometimes not the case, for example in the event of rain or moisture.

In many cases, a cap according to the present disclosure can be placed on an existing respiratory mask. In many cases, the respiratory mask does not need to be modified. Instead, the cap can be adapted to the existing filter unit.

Preferably, the or each cap is configured as a one-piece component. In many cases, it is possible to manufacture the cap by molding, in particular by injection-molding.

In one example embodiment, the assembly according to the first alternative is configured as follows: The cap comprises two projections, which are spaced apart from each other. The filter unit comprises two corresponding receiving elements, which are spaced apart from each other. If the cap is placed, each projection on the cap engages in a respective corresponding receiving element. The filter unit is located between the two projections of the placed cap. The compression axis extends between these two projections. According to the second alternative, the assembly according to this example embodiment is configured as follows: The filter unit comprises two projections. The cap comprises two corresponding receiving elements. If the cap is placed, each projection of the filter unit engages in a respective corresponding receiving element. The filter unit is located between the two corresponding receiving elements of the placed cap. The compression axis extends between these two corresponding receiving elements.

Both alternatives lead to the cap being held on the filter unit with even greater reliability compared to an example embodiment comprising just one projection and/or just one receiving element.

According to the present disclosure, the placed cap protrudes beyond the filter unit in at least one direction, said direction being parallel to the compression axis. Therefore, a gap between the placed cap and the filter unit occurs in at least one segment around the filter unit. Preferably, the placed cap protrudes beyond the filter unit in two opposite directions. As a result, two spaced-apart segments occur between the placed cap and the filter unit. A gap is formed in each segment. Both the or each projection and the or each corresponding receiving element are arranged outside the or each gap. Due to said gap(s), the placed cap can be compressed along the compression axis and removed from the filter unit.

In one possible embodiment, the following effect is achieved if the cap is placed on the filter unit: The placed cap prevents a gas mixture from flowing from the surrounding environment, through the filter unit, toward the main body. As a result, the filter unit and in particular a filter element in the filter unit are particularly well protected against environmental influences. By way of example, an elastic element seals the gap. The elastic element can be compressed and then reversibly deforms. If the cap is placed, the respiratory mask obviously cannot be used by a user for wearing the respiratory mask and breathing in filtered ambient air.

However, in one alternative example embodiment, ambient air can flow through the filter unit and reach the main body even if the cap is placed, and a user can use the respiratory mask and breathe in filtered ambient air even if the cap is placed. The placed cap protects the filter unit from dirt and moisture during use. According to this example embodiment, the or each gap just described establishes a fluidic connection between the surrounding environment and the filter unit. This fluidic connection passes the or each projection and the or each corresponding receiving element. Ambient air can flow through this fluidic connection to the filter unit. The or each projection and the or each corresponding receiving element ensure that, despite the fluidic connection, the placed cap does not slip off the filter unit.

If no cap is placed on the filter unit, the pneumatic resistance that the respiratory mask offers to the inflowing ambient air is generally lower than if the cap is placed. By virtue of the example embodiment just described, in which a fluidic connection is established even if the cap is placed, a user can therefore decide between the following two alternatives: The user uses the respiratory mask with the cap placed (better protection against dirt particles and moisture) or with the cap removed (lower pneumatic resistance).

In one example embodiment, if the cap is placed, at least one guide element is located in the or a gap, preferably at least one guide element is located in each gap, particularly preferably at least two guide elements are located in each gap. The or each guide element is attached to the inside of the cap, i.e. faces toward the filter unit if the cap is placed. The cap together with the guide elements can be removed from the filter unit.

The or each guide element has a beveled edge. The filter unit comprises at least one projection. In one example embodiment, the projection is configured as a circumferential projecting edge. In another example embodiment, the projection comprises at least two spaced-apart segments. The respective beveled edge of a guide element faces toward the projection, in particular toward the projecting edge, of the filter unit if the cap is placed. The guide elements are positioned as follows and the assembly is configured as follows: If the cap is placed and the cap is compressed along the compression axis, the following happens: The respective beveled edge of each guide element slides over the or a projection of the filter unit, in particular over the circumferential projecting edge. The cap is thereby moved away from the filter unit.

This example embodiment also makes it easier to remove the placed cap from the filter unit. A single action is sufficient, namely compressing the cap along the compression axis. The following two effects are achieved as a result of this one action:
The or each projection slides out of the respective corresponding receiving element.
The cap is moved linearly away from the filter unit.

In many cases, thanks to the example embodiment comprising the guide elements, it is not necessary first to compress the cap and subsequently pull it away actively from the filter unit.

### BRIEF DESCRIPTION OF THE DRAWINGS

The present disclosure will be described below on the basis of an exemplary embodiment. In the drawings:

FIG. 1 shows a respiratory mask with two filter units and without caps;

FIG. 2 shows a filter unit without a cap, viewed at an angle from above;

FIG. 3 shows the filter unit of FIG. 2, viewed at an angle from below;

FIG. 4 shows a cap, viewed at an angle from above;

FIG. 5 shows the cap of FIG. 4, viewed from below;

FIG. 6 shows a cross-section through the cap in the plane I-I from FIG. 5;

FIG. 7 shows a cross-section through the cap in the plane II-II from FIG. 5;

FIG. 8 shows the right filter unit from FIGS. 1 to 3 and a cap in the plane I-I from FIG. 5 prior to being placed;

FIG. 9 shows the assembly viewed from the same direction as FIG. 8, after the cap has been placed;

FIG. 10 shows the right filter unit from FIGS. 1 to 3 and the cap in the plane II-II from FIG. 5 after being placed; and

FIG. 11 shows the right filter unit from FIGS. 1 to 3 and the cap after being placed, viewed from the same direction as FIGS. 3 and 5.

### DETAILED DESCRIPTION

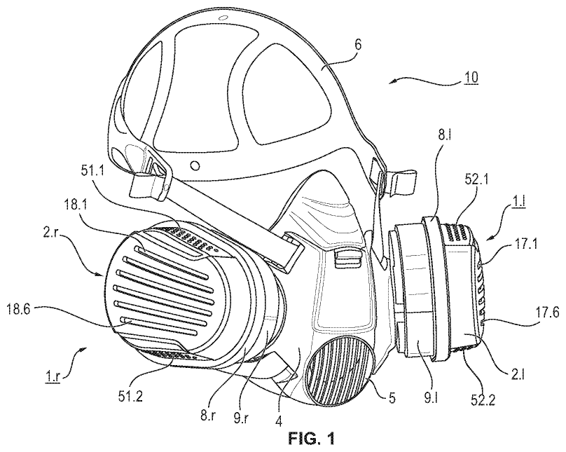

FIG. 1 shows an example of a respiratory mask 10 without a cap according to the present disclosure. The respiratory mask 10 enables a user to remain in an environment in which the ambient air contains or may contain harmful substances and/or particles.

A main body 4 of the respiratory mask 10 bears against the face of a user (not shown) in a fluid-tight manner and covers the mouth and nose of the user. Formed in the main body 4 is an exhalation valve 5, which is located in front of the user's mouth and allows exhaled air to pass through, but does not allow air from the surrounding environment to flow inward. A strap 6 keeps the main body 4 on the user's head.

The main body 4 holds a left filter unit 1.l and a right filter unit 1.r. The terms “left” and “right” relate to the line of sight of a user of the respiratory mask 10. The two filter units 1.l, 1.r each have an approximately oval main surface and therefore have two longitudinal sides and two transverse sides. The left filter unit 1.l is attached to a left adapter 9.l by means of a left bayonet fastening, and the right filter unit 1.r is attached to a right adapter 9.r by means of a right bayonet fastening. The left filter unit 1.l comprises a two-part housing having an outer housing part 2.l and an inner housing part 3.l, and the right filter unit 1.r comprises a two-part housing having an outer housing part 2.r and an inner housing part 3.r. Only the two outer housing parts 2.l, 2.r can be seen in FIG. 1, but not the two inner housing parts 3.l, 3.r.

The left outer housing part 2.l includes a circumferential left ridge 8.l, and the right outer housing part 2.r includes a circumferential right ridge 8.r. Six approximately parallel slots 17.1, . . . , 17.6 are formed in the left outer housing part 2.l, and six approximately parallel slots 18.1, . . . , 18.6 are formed in the right outer housing part 2.r. Two left gripping surfaces 52.1, 52.2 with three rows of protruding bumps are formed in two opposite longitudinal sides of the left outer housing part 2.l, and two right gripping surfaces 51.1, 51.2 with three rows of protruding bumps are formed in two opposite longitudinal sides of the right outer housing part 2.r.

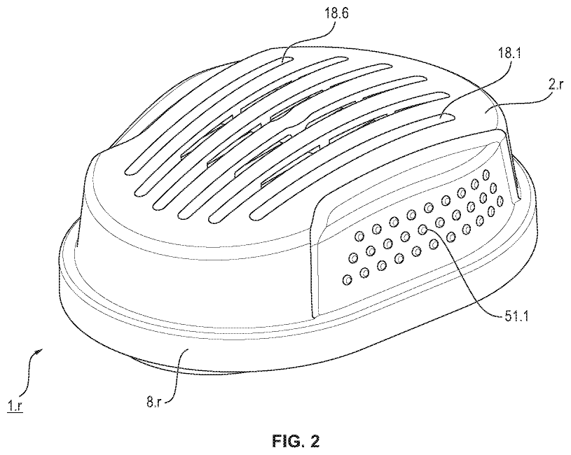

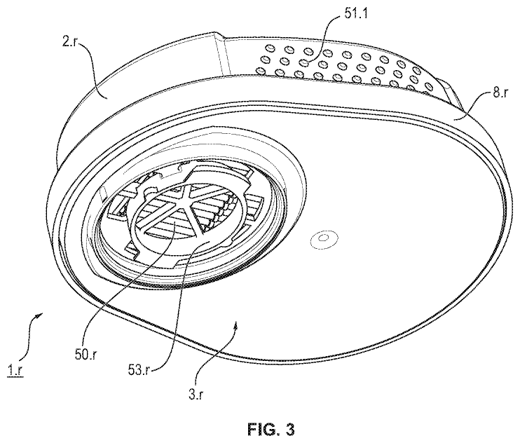

FIG. 2 shows a perspective view of the right filter unit 1.r viewed at an angle from above, so that the right outer housing part 2.r faces toward the viewer. FIG. 3 shows a perspective view of the right filter unit 1.r viewed at an angle from below. The designations “above” and “below” relate to an orientation of the filter unit 1.r if the filter unit 1.r is resting on a table and the inner housing part 3.r is at the bottom. In FIG. 2, the outer housing part 2.r faces toward the viewer, and in FIG. 3, the inner housing part 3.r faces toward the viewer. The same reference signs have the same meanings as in FIG. 1.

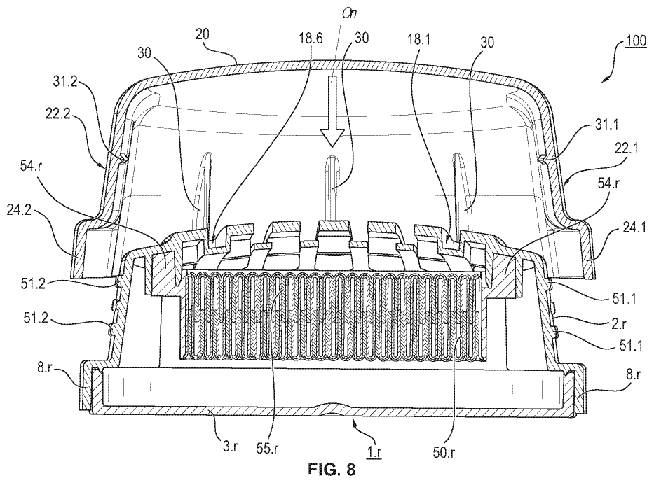

FIG. 3 also shows a filter-side part 53.r of a bayonet fastening. The filter-side part 53.r is formed in the inner housing part 3.r. A corresponding part (not shown) of the bayonet fastening is located on the right adapter 9.r. By means of this bayonet fastening, the right filter unit 1.r can be detachably connected to the main body 4. A folded paper filter 50.r can be seen through the filter-side part 53.r of the bayonet fastening. A holder 54.r holds the paper filter 50.r on the right outer housing part 2.r; see FIGS. 8 to 10. A comb-shaped holding element 55.r maintains the shape of the folded paper filter 50.r. The left filter unit 1.l is constructed in a corresponding manner.

If the user breathes in, ambient air can ideally only reach the user's mouth and nose through a filter unit 1.l, 1.r. The ambient air flows through the slots 17.1, . . . , 17.6, 18.1, . . . , 18.6 in the housing 2.l, 3.l, 2.r, 3.r into the interior of the housing, through the paper filter 50.l, 50.r and then through the bayonet fastening comprising the filter-side part 53.l, 53.r and through the adapter 9.l, 9.r to the user's mouth and nose. Ideally, the inflowing ambient air is unable to bypass a filter unit 1.l, 1.r or a paper filter 50.l, 50.r.

A cap can be placed on each outer housing part 2.l, 2.r and can be removed again therefrom. If the cap is placed, the filter unit 1.l, 1.r and in particular the paper filter 50.l, 50.r are protected against dirt particles and moisture.

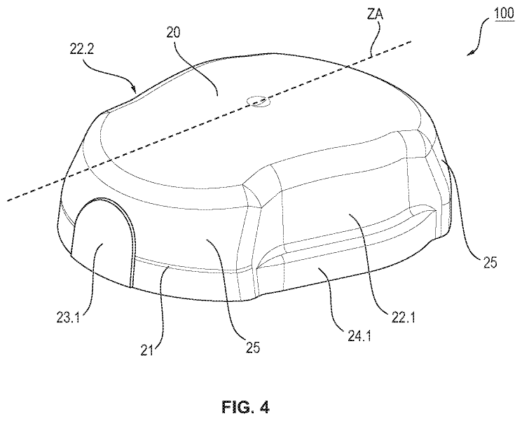

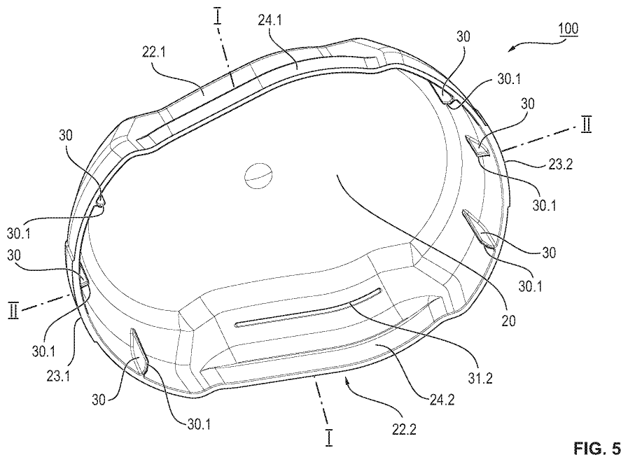

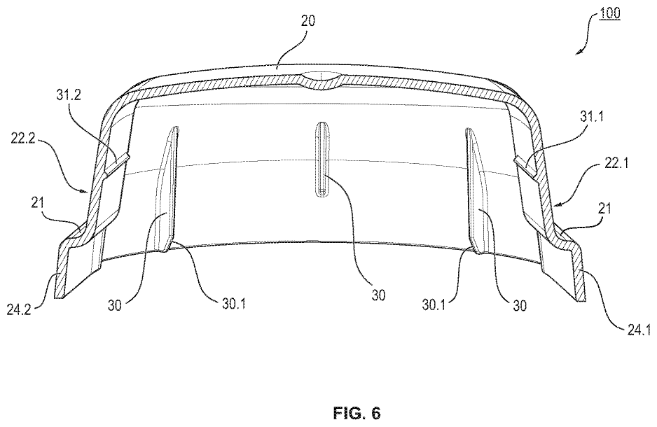

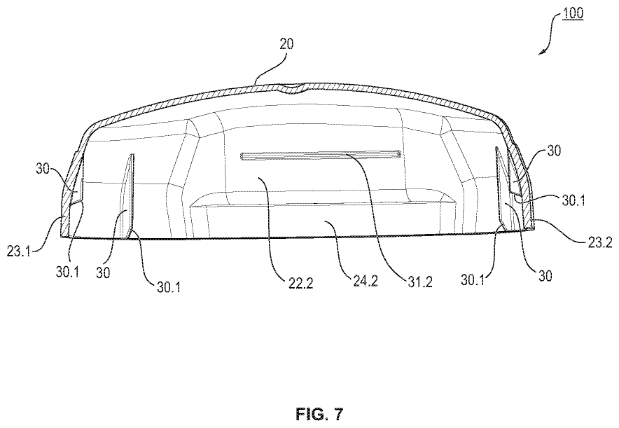

FIGS. 4 and 5 show two perspective views of a cap 100 from two different directions, namely from the outside (FIG. 4) and from the inside (FIG. 5). FIG. 6 shows a cross-section through the cap 100 in the plane I-I from FIG. 5, and FIG. 7 shows a cross-section in the plane II-II from FIG. 5.

The cap 100 is mirror-symmetrical and therefore can optionally be placed on and removed from the left filter unit 1.l or the right filter unit 1.r. The one-piece cap 100 comprises an approximately oval curved main surface 20 and a circumferential lateral surface 25 with a circumferential edge 21. In one example embodiment, the oval main surface 20 is slightly larger than the main surface of a filter unit 1.l, 1.r. If the cap 100 is placed on the right filter unit 1.r, the oval main surface 20 is located in front of the slots 18.1, . . . , 18.6 of the right outer housing part 2.r, and the circumferential lateral surface 25 surrounds the outer housing part 2.r. The same applies to the left filter unit 1.l.

Two opposite indentations 22.1, 22.2 are formed in the circumferential lateral surface 25 on two opposite longitudinal sides, namely one indentation 22.1, 22.2 per longitudinal side. The indentation 22.1 is bounded at one side by the oval main surface 20 and at the other side by a ridge 24.1. The same applies to the opposite indentation 22.2 with a ridge 24.2. An elongated projection 31.1, 31.2 is formed on the inner side of each indentation 22.1, 22.2; see FIG. 6. The two projections 31.1, 31.2 project inward, thus facing toward each other. Three guide elements (fins) 30, each having an angled (beveled) edge 30.1, are formed on the inside of two opposite transverse sides of the lateral surface 25; see FIG. 5. If the cap 100 is placed, the beveled edges 30.1 of the guide elements 30 face toward the circumferential ridge 8.r. Two gripping aids in the form of two projections 23.1, 23.2 are formed on the outside of the two opposite transverse sides; see FIG. 4.

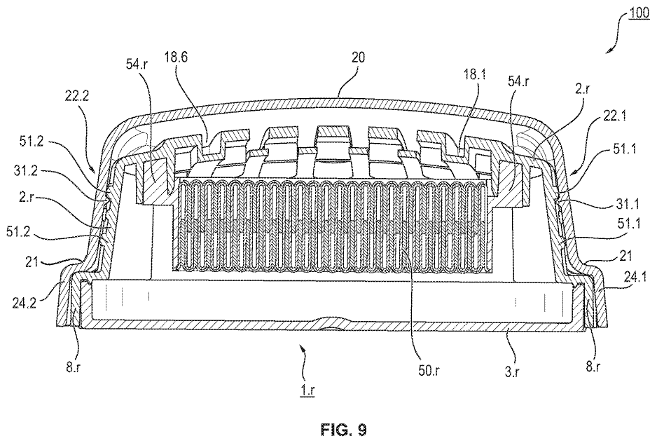

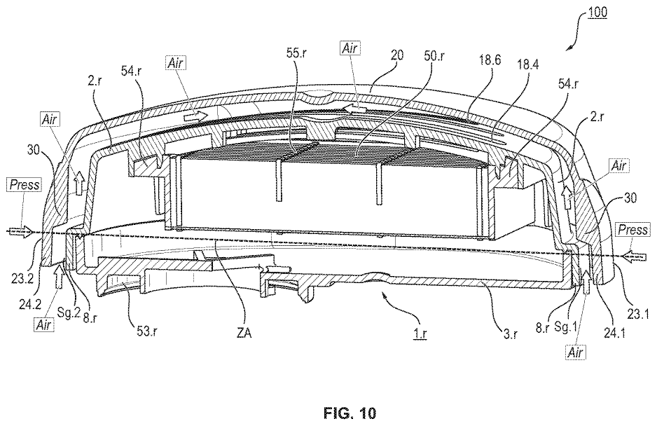

FIGS. 8 and 9 show a first cross-section through a combination, the combination shown comprising the cap 100 and the right filter unit 1.r. The cross-section through the cap 100 corresponds to the cross-section in the plane I-I from FIG. 5. FIG. 10 shows a second cross-section through this assembly, the cross-section through the cap 100 corresponding to the cross-section in the plane II-II from FIG. 5. Again, the same reference signs have the same meanings.

It can be seen in the figures that the cap 100 is slightly larger than the right outer housing part 2.r. In FIG. 8, the cap 100 is not yet placed, and therefore a vertical gap occurs between the cap 100 and the right filter unit 1.r. In FIG. 9, the cap 100 is placed on the right filter unit 1.r.

As already mentioned, two elongated projections 31.1, 31.2 are arranged on the inside of the two longitudinal sides of the cap 100; see FIG. 5. The projections 31.1, 31.2 face inward, extend parallel to the main surface 20, and are perpendicular to the corresponding plane of the drawing in FIGS. 8 and 9. As can be seen in FIG. 9, if the cap 100 is placed, the two projections 31.1, 31.2 engage in the two gripping surfaces 51.1, 51.2. These gripping surfaces 51.1, 51.2 are located on the outside of two opposite longitudinal sides of the right outer housing part 2.r and between the two projections 31.1, 31.2 if the cap 100 is placed. As a result, the cap 100 is held at two opposite longitudinal sides on the right filter unit 1.r and cannot move away from the right filter unit 1.r on its own, i.e. in the situation of FIG. 9 cannot move upward.

The cap 100 is impermeable to fluids. The cap 100 has a rest state and can be elastically, i.e. reversibly, deformed. While being deformed, the cap 100 exerts a restoring force, and the restoring force tends to return the cap 100 to the rest state. The cap 100 is made of a suitable material, preferably an elastic plastic. It is also possible to manufacture the cap from a thermoplastic elastomer, in particular by injection-molding, or from silicone.

To detachably connect the cap 100 to the right filter unit 1.r, a user applies the cap 100 to the right filter unit 1.r and pushes it toward the right filter unit 1.r, i.e. downward in the example of FIGS. 8 and 9, as indicated by the downward-pointing arrow On in FIG. 8. During this movement, the cap 100 slides over the right outer housing part 2.r toward the right circumferential ridge 8.r until the two projections 31.1, 31.2 latch into the two gripping surfaces 51.1, 51.2. In the exemplary embodiment, the two gripping surfaces 51.1, 51.2 also function as receiving elements. The user can apply the cap 100 using one hand and in a single movement and can slide it onto the right filter unit 1.r until the two projections 31.1, 31.2 latch into place.

It can be seen in FIG. 10 that a left gap and a right gap occur between the placed cap 100 and the filter unit 1.r. Ambient air can flow through this gap toward the slots 18.1, . . . , 18.6 of the filter unit 1.r. The incoming ambient air is indicated by two arrows labeled Air. The ambient air Air first flows past the circumferential right ridge 8.r, then past the right outer housing part 2.r, and then through the slots 18.1, . . . , 18.6 toward the paper filter 50.r.

In one alternative (not shown), no gap occurs between the placed cap 100 and the filter unit 1.r. For example, the cap 100 is smaller than shown in FIG. 10. Or a circumferential seal is arranged inside the cap 100.

In the exemplary embodiment, as can be seen in FIG. 10, the user can use the respiratory mask 10 even if the cap 100 is placed. How the user removes the cap 100 from the right filter unit 1.r will be described below. If the cap 100 is removed, a user can achieve a significantly larger volume flow of ambient air through the filter unit 1.r toward his face as a result of his own respiratory effort, and the pneumatic resistance is lower than if the cap 100 is placed.

To remove the cap 100, the user presses on the two opposite gripping aids 23.1, 23.2 in the two opposite transverse sides of the cap 100; see FIG. 4. This movement is indicated in FIG. 10 by two opposing horizontal arrows labeled Press. As a result of the user pressing on the two gripping aids 23.1, 23.2, the user compresses the elastically deformable cap 100. The distance between the two transverse sides of the cap 100 is reduced, and accordingly the distance between the two longitudinal sides is increased. As a result, the two projections 31.1, 31.2 slide out of the two gripping surfaces 51.1, 51.2. The guide elements 30 having the beveled edges 30.1 slide over the circumferential ridge 8.r. This causes the cap 100 to move away from the right filter unit 1.r. The cap 100 can then be set aside. To separate the cap 100 from the right filter unit 1.r, the user only has to perform one single action, namely compressing the cap 100 at its two transverse sides. Afterwards, it is easy to move it away. In particular, it is not necessary to pull the cap 100 away from the right filter unit 1.r with force or to turn the cap 100.

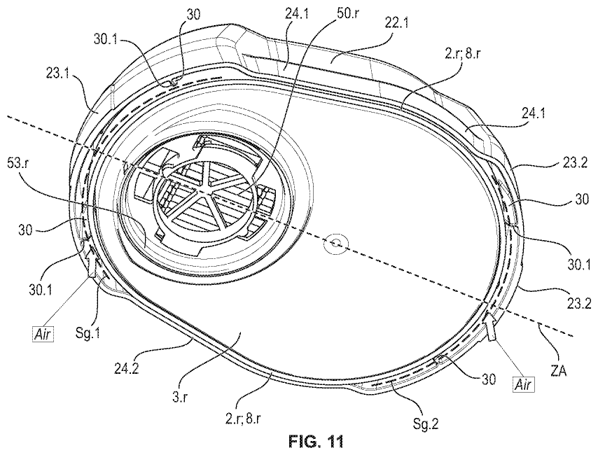

FIG. 11 shows the right filter unit 1.r with the placed cap 100 in a perspective view from below, i.e. approximately from the same viewing direction as FIGS. 3 and 5. It can be seen that the cap 100 is at a greater distance from the right outer housing part 2.r in the region of the two transverse sides having the two gripping aids 23.1, 23.2 than in the region of the two longitudinal sides having the two projections 31.1, 31.2 which engage in the two gripping surfaces 51.1, 51.2. The placed cap 100 protrudes beyond the filter unit 1.r along a compression axis ZA. A gap between the filter unit 1.r and the placed cap 100 is formed in each of two segments Sg.1, Sg.2 around the filter unit 1.r. The compression axis ZA extends through these two segments Sg.1, Sg.2 and thus through these two gaps.

Each guide element 30 is positioned in a region in which the placed cap 100 protrudes beyond the filter unit 1.r. Because the cap 100 protrudes beyond the filter unit 1.r in two directions and thus two gaps are formed in the two segments Sg.1, Sg.2, the cap 100 can be compressed as just described at the two transverse sides, i.e. along the compression axis ZA, as a result of which the guide elements 30 having the beveled edges 30.1 move the cap 100 away from the right filter unit 1.r.

List of reference signs

| | |
|---|---|
| 1.l, 1.r | left or right filter unit, comprises the housing 2.l, 3.l or 2.r, 3.r, |
| | the filter-side part 53.l, 53.r and the paper filter 50.l or 50.r, |
| | can be closed by the cap 100 |
| 2.l, 2.r | left or right outer housing part of the filter unit 1.l, 1.r |
| 3.l, 3.r | left or right inner housing part of the filter unit 1.l, 1.r |
| 4 | main body of the respiratory mask 10, carries the two filter |
| | units 1.l, 1.r |
| 5 | exhalation valve in the main body 4 |
| 6 | strap of the respiratory mask 10, mounted to the main body 4 |
| 8.l, 8.r | circumferential left or right ridge on the outer housing part 2.l, |
| | 2.r, operates as a projection, in particular a circumferential |
| | projecting edge |
| 9.l, 9.r | left or right adapter between the main body 4 and the filter |
| | units 1.l, 1.r |
| 10 | respiratory mask, comprises the main body 4 with the |
| | exhalation valve 5, the strap 6 and the two filter units 1.l, 1.r |
| 17.1, . . . , | parallel slots in the left outer housing part 2.l |
| 17.6 | |
| 18.1, . . . , | parallel slots in the right outer housing part 2.r |
| 18.6 | |
| 20 | oval curved main surface of the cap 100 |
| 21 | circumferential edge of the cap 100, belongs to the lateral |
| | surface 25 |
| 22.1, 22.2 | opposite indentations in the longitudinal sides of the |
| | circumferential lateral surface 25 |
| 23.1, 23.2 | gripping aids in the transverse sides of the circumferential |
| | lateral surface 25 |
| 24.1, 24.2 | ridge bounding the indentation 22.1, 22.2 |
| 25 | circumferential lateral surface of the cap 100, adjoins the |
| | main surface 20, comprises the edge 21, the indentations |
| | 22.1, 22.2 and the ridges 24.1, 24.2 |
| 30 | guide element on a transverse side in the interior of the cap |
| | 100, comprises a beveled edge 30.1 which faces toward the |
| | circumferential ridge 8.r |
| 30.1 | beveled edge of the guide element 30 |
| 31.1, 31.2 | projection on a longitudinal side in the interior of the cap 100, |
| | engages in a gripping surface 51.1, 51.2 or 52.1, 52.2 |
| 50.l, 50.r | paper filter of the filter unit 1.l, 1.r, surrounded by the housing |
| | 2.l, 3.l or 2.r, 3.r, is kept in shape by the holder 54.l, 54.r on |
| | the outer housing part 2.l, 2.r and by the holding element |
| | 55.l, 55.r, filters out particles and/or harmful substances from |
| | the ambient air Air |
| 51.1, 51.2 | gripping surface with bumps in the longitudinal sides of the |
| | right outer housing part 2.r, functions as a receiving element |
| 52.1, 52.2 | gripping surface with bumps in the longitudinal sides of the |
| | left outer housing part 2.l, functions as a receiving element |
| 53.l, 53.r | filter-side part of a bayonet fastening, formed in the inner |
| | housing part 3.l, 3.r, can be connected to a corresponding |
| | part on the main body 4 |
| 54.l, 54.r | holder, holds the paper filter 50.l, 50.r in the outer housing |
| | part 2.l, 2.r |
| 55.l, 55.r | comb-shaped holding element, maintains the shape of the |
| | folded paper filter 50.l, 50.r |
| 100 | cap for a filter unit 1.l, 1.r, comprises the approximately oval |
| | main surface 20, the circumferential lateral surface 25, the |
| | guide elements 30 and the projections 31.1, 31.2 |
| Air | ambient air, which flows through the segments Sg. 1, Sg. 2 |
| | into the filter unit 1.r even if the cap 100 is placed |
| On | direction in which the cap 100 can be placed on the right |
| | filter unit 1.r |
| Press | opposite directions, in which the cap 100 can be compressed |
| | in order to remove it from the filter unit, are parallel to the |
| | compression axis ZA |
| Sg. 1, Sg. 2 | segments around the filter unit 1.r, in each of which a gap is |
| | formed between the filter unit 1.r and the placed cap 100 |
| ZA | compression axis, along which the placed cap 100 can be |
| | compressed, in the example embodiment at the same time |
| | the longitudinal axis of the cap 100 |

1. An assembly comprising a respiratory mask and a cap, wherein the respiratory mask comprises:
a main body; and
a filter unit,
wherein the main body is configured to bear against the face of a user of the respiratory mask in a fluid-tight manner,
wherein the filter unit:
is configured to be connected to the main body, and
is configured to filter out at least one of particles and harmful substances from a gas mixture that flows from an environment surrounding the respiratory mask, through the filter unit, toward the main body,
wherein the cap:
is configured to be placed on the filter unit and to be removed again from the filter unit, and
is reversibly deformable,
wherein, in a first alternative, the cap comprises a first projection and the filter unit comprises a corresponding first receiving element, and, in a second alternative, the filter unit comprises a second projection and the cap comprises a corresponding second receiving element,
wherein, if the cap is placed on the filter unit:
in the first alternative, the first projection engages in the first receiving element, and
in the second alternative, the second projection engages in the second receiving element,
wherein the placed cap:
protrudes along a compression axis beyond the filter unit; and
is configured to be reversibly compressed along the compression axis,
wherein, in the first alternative, the first projection and, in the second alternative, the second receiving element is arranged at a respective distance from the compression axis, and
wherein, as a result of the cap being compressed along the compression axis:
in the first alternative, the first projection slides out of the corresponding first receiving element,
in the second alternative, the second projection slides out of the corresponding second receiving element, and
the cap can be removed from the filter unit.

2. The assembly of claim 1, wherein:
in the first alternative the cap further comprises a first additional projection and the filter unit further comprises a corresponding first additional receiving element, wherein the filter unit is located between the first projection and the first additional projection if the cap is placed, and
in the second alternative the filter unit further comprises a second additional projection and the cap further comprises a corresponding second additional receiving element, wherein the filter unit is located between the corresponding second receiving element and the corresponding second additional receiving element if the cap is placed,
wherein, as a result of the cap being compressed along the compression axis:
in the first alternative, the first additional projection slides out of the corresponding first additional receiving element, and
in the second alternative, the second additional projection slides out of the corresponding second additional receiving element.

3. The assembly of claim 1, wherein:
if the cap is placed on the filter unit, a gap between the cap and the filter unit occurs in a segment of the filter unit,
wherein:
in the first alternative, the first projection and the corresponding first receiving element are located outside the gap, and
in the second alternative, the second projection and the corresponding second receiving element are located outside the gap,
wherein, if the cap is placed on the filter unit, the gap establishes a fluidic connection between a surrounding environment of the respiratory mask and the filter unit.

4. The assembly of claim 3, wherein the compression axis extends through the gap.

5. The assembly of claim 1, wherein:
the cap comprises a guide element; and
the filter unit comprises a circumferential projecting edge,
wherein, if the cap is placed on the filter unit, the guide element faces toward the filter unit,
wherein the guide element has a beveled edge, and
wherein, if the cap is placed on the filter unit, the beveled edge is positioned relative to the circumferential projecting edge, in such a way that, as a result of the cap being compressed along the compression axis:
the beveled edge of the guide element slides over the circumferential projecting edge, and
the cap can be moved away from the filter unit.

6. The assembly of claim 5, wherein:
the cap further comprises a second guide element having a second beveled edge,
wherein, if the cap is placed, the filter unit is located between the guide element and the second guide element, and
wherein, as a result of the cap being compressed, the beveled edges of the guide element and the second beveled edge of the second guide element slide over the circumferential projecting edge of the filter unit.

7. The assembly of claim 1, wherein, if the cap is placed, the placed cap prevents a gas mixture to flow from a surrounding environment, through the filter unit, toward the main body.

8. The assembly of claim 1, wherein
the assembly further comprises a second cap, and
the respiratory mask further comprises a second filter unit,
wherein the cap is configured to be placed on the filter unit and to be removed again from the filter unit, and
wherein the second cap is configured to be placed on the second filter unit and to be removed again from the second filter unit.

9. A method for operating an assembly comprising a respiratory mask and a cap:
wherein the respiratory mask comprises:
a main body; and
a filter unit,
wherein the main body is configured to bear against the face of a user of the respiratory mask in a fluid-tight manner,
wherein the cap:
is configured to be placed on the filter unit and to be removed again from the filter unit, and
is reversibly deformable,
wherein, in a first alternative, the cap comprises a first projection and the filter unit comprises a corresponding first receiving element, and, in a second alternative, the filter unit comprises a second projection and the cap comprises a corresponding second receiving element,
wherein, if the cap is placed on the filter unit:
in the first alternative, the first projection engages in the first receiving element, and
in the second alternative, the second projection engages in the second receiving element,
wherein the placed cap:
protrudes along a compression axis beyond the filter unit; and
is configured to be reversibly compressed along the compression axis,
wherein, in the first alternative, the first projection and, in the second alternative, the second receiving element is arranged at a respective distance from the compression axis,
wherein, as a result of the cap being compressed along the compression axis:
the cap can be removed,
in the first alternative, the first projection slides out of the corresponding first receiving element, and
in the second alternative, the second projection slides out of the corresponding second receiving element,
wherein, before starting the method, the cap is removed from the filter unit, and
wherein the method comprises:
placing the cap on the filter unit; and
pressing the cap against the filter unit until:
in the first alternative, the first projection engages in the first receiving element of the filter unit; and
in the second alternative, the second projection engages in the second receiving element.

10. The method of claim 9, wherein:
the cap comprises a guide element; and
the filter unit comprises a circumferential projecting edge,
wherein, if the cap is placed on the filter unit, the guide element faces toward the filter unit,
wherein the guide element has a beveled edge, and
wherein, if the cap is placed on the filter unit, the beveled edge is positioned relative to the circumferential projecting edge, in such a way that, as a result of the cap being compressed along the compression axis:
the beveled edge of the guide element slides over the circumferential projecting edge, and
the cap can be moved away from the filter unit.

11. The method of claim 10:
wherein, before starting the method, the cap is placed on the filter unit, and
wherein the method comprises:
compressing the cap;
as a result of compressing the cap, the beveled edge of the guide element slides over the circumferential projecting edge, and
as a result of the beveled edge sliding over the circumferential projecting edge, the cap is moved away from the filter unit and can be removed.
